(19) United States
(12) Patent Application Publication
(10) Pub. No.: US 2026/0136217 A1
(43) Pub. Date: May 14, 2026

(54) MULTI-USER ENHANCED DISTRIBUTED CHANNEL ACCESS (MU-EDCA) OPTIMIZATION FOR HIGH-DENSITY (HD) ENTERPRISES

(71) Applicant: Cisco Technology, Inc., San Jose, CA (US)

(72) Inventors: Malcolm Muir Smith, Richardson, TX (US); Brian D. Hart, Sunnyvale, CA (US); Sanjay Katabathuni, Fremont, CA (US); Venkataprasad Chirreddy, Milpitas, CA (US)

(73) Assignee: Cisco Technology, Inc., San Jose, CA (US)

(21) Appl. No.: 19/281,301

(22) Filed: Jul. 25, 2025

Related U.S. Application Data
(60) Provisional application No. 63/718,473, filed on Nov. 8, 2024.

(51) Int. Cl. H04W 24/08; H04W 74/08

(52) U.S. Cl. CPC H04W 24/08; H04W 74/08

(57) ABSTRACT

Multi-User Enhanced Distributed Channel Access (MU-EDCA) optimization for High-Density (HD) enterprises may be provided. An observed Enhanced Distributed Channel Access (EDCA) latency Probability Density Function (PDF) based on a plurality of parameters may be determined. Next, a predicted MU-EDCA latency PDF based on the plurality of parameters may be determined. Then MU-EDCA may be enabled when the predicted MU-EDCA latency PDF indicates a better delay bound than the EDCA latency PDF.

### RELATED APPLICATION

Under provisions of 35 U.S.C. § 119(e), Applicant claims the benefit of U.S. Provisional Application No. 63/718,473, filed Nov. 8, 2024, which is incorporated herein by reference.

### TECHNICAL FIELD

The present disclosure relates generally to providing Multi-User Enhanced Distributed Channel Access (MU-EDCA) optimization for High-Density (HD) enterprises.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Multi-User Enhanced Distributed Channel Access (MU-EDCA) optimization for High-Density (HD) enterprises;

FIG. 2 is a flow chart of a method for providing MU-EDCA optimization for HD enterprises; and

FIG. 3 is a block diagram of a computing device.

### DETAILED DESCRIPTION

### Overview

Multi-User Enhanced Distributed Channel Access (MU-EDCA) optimization for High-Density (HD) enterprises may be provided. An observed Enhanced Distributed Channel Access (EDCA) latency Probability Density Function (PDF) based on a plurality of parameters may be determined. Next, a predicted MU-EDCA latency PDF based on the plurality of parameters may be determined. Then MU-EDCA may be enabled when the predicted MU-EDCA latency PDF indicates a better delay bound than the EDCA latency PDF.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Conventional Wi-Fi6/Institute of Electrical and Electronics Engineers (IEEE) 802.11ax Triggered Uplink Access (TUA) and Wi-Fi7/IEEE 802.11be TUA Optimized (TUA-O) operational modes may be selectively enabled based on prevailing channel and client capabilities. Prevailing channel and client capabilities may comprise, but not limited to, the number of TUA capable client devices, the number of non-TUA capable client devices, and Channel Utilization (CU) (e.g., 60%) for example. When enabled, unique MU-EDCA parameters may be advertised to the Basic Service Set (BSS) such as Arbitration Inter-Frame Space Number (AIFSN), MU-EDCA Timeout, etc. in order to provide lower collision probability and hence lower tail latency (e.g. 90%) by limiting Carrier Sense Multiple Access with Collision Avoidance (CSMA/CA) via the AIFSN and in particular the MU EDCA Timeout. For example, current AP processes may set MU-EDCA parameters such as the Timeout (TO) using a linear interpolation of the number of TUA-capable client devices in the BSS. Under modest client device density conditions, this may be shown to be reasonably effective, however this may lack the specificity of High-density (HD) client scenarios where the latency may erode quickly (e.g., non-linearly) with added clients and/or low CU (e.g. 10%). Furthermore, the process may ignore the actual Up Link (UL) latency metrics that have a reasonable probability of being available. Accordingly, embodiments of the disclosure may address these issues by providing a HD optimized Wi-Fi 6/7 TUA process for bounding latency.

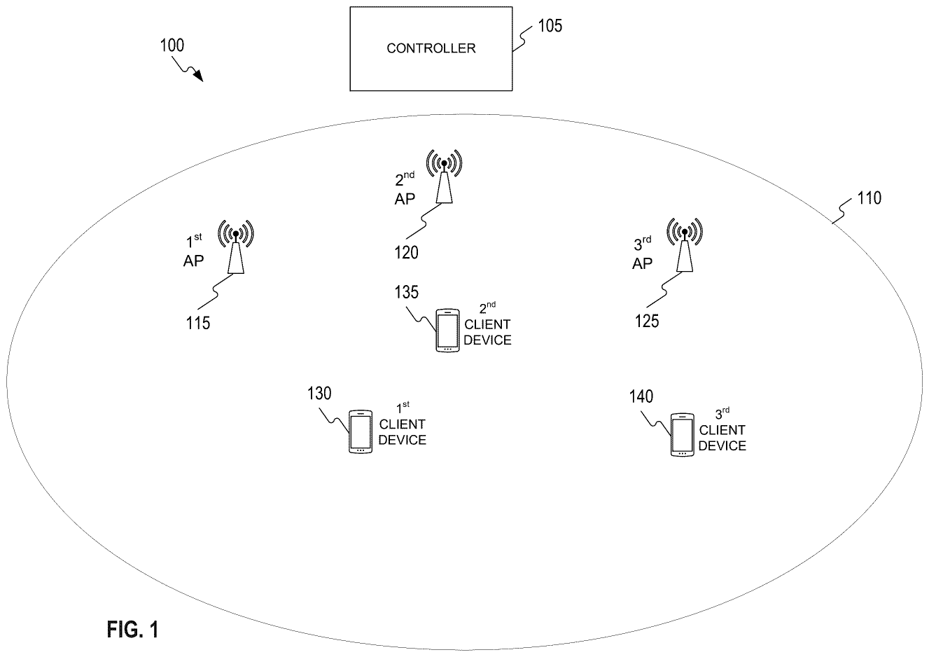

FIG. 1 shows an operating environment 100 for providing Multi-User Enhanced Distributed Channel Access (MU-EDCA) optimization for High-Density (HD) enterprises. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band. The two or more links on any given one of the plurality of client devices may be made with any one AP or with any combination of the APs.

The plurality of APs and the plurality of client devices may also have an Ultra-Wide Band (UWB) radio that may use UWB radio technology using a very low energy level for short-range, high-bandwidth communications over a large portion of the radio spectrum. UWB may transmit information across a wide bandwidth (e.g., >500 MHz). This may allow for the transmission of a large amount of signal energy without interfering with conventional narrowband and carrier wave transmission in the same frequency band. Regulatory limits in many countries may allow for this efficient use of radio bandwidth, and enable high-data-rate personal area network (PAN) wireless connectivity, longer-range low-data-rate applications, and the transparent co-existence of radar and imaging systems with existing communications systems.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide MU-EDCA optimization for HD enterprises.

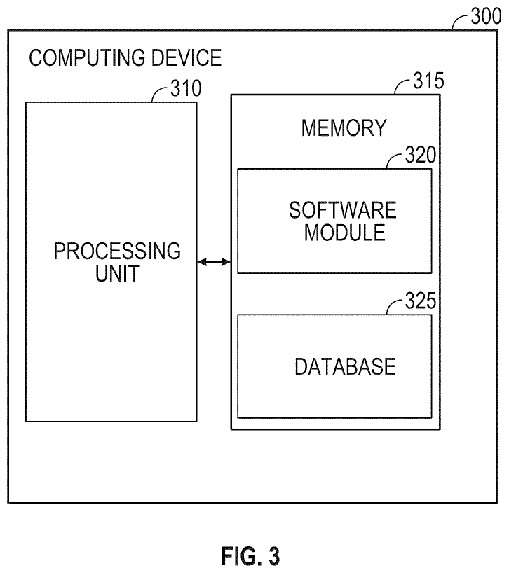

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

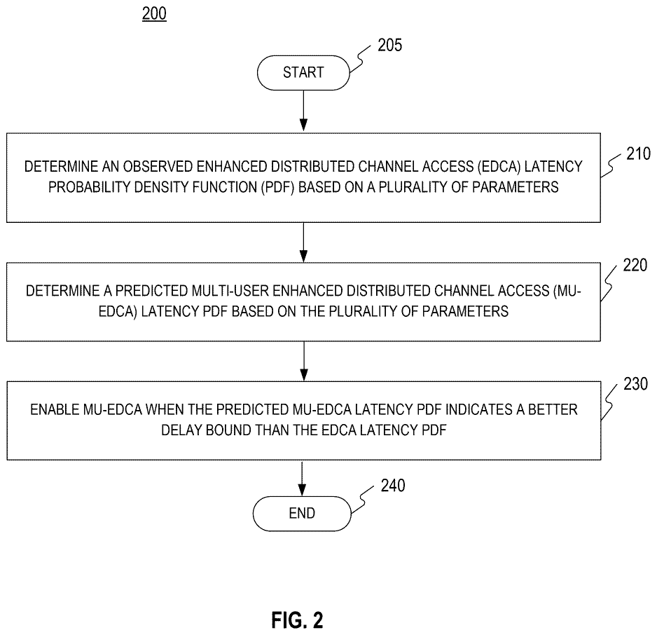

FIG. 2 is a flow chart setting forth the general stages involved in a method 200 consistent with embodiments of the disclosure for providing MU-EDCA optimization for HD enterprises. Method 200 may be implemented using a computing device 300 as described in more detail below with respect to FIG. 3. Computing device 300 may be embodied, for example, by any of the plurality of APs or controller 105. Ways to implement the stages of method 200 will be described in greater detail below.

Method 200 may begin at starting block 205 and proceed to stage 210 where computing device 300 may determine an observed Enhanced Distributed Channel Access (EDCA) latency Probability Density Function (PDF) based on a plurality of parameters. For example, embodiments of the disclosure may observe for EDCA (e.g., from simulations and field data) a single mode Cumulative Distribution Function (CDF) of latency with a long tail but often with a better mean latency than the MU-EDCA CDF. The computation of these PDFs may be made, for example: i) via explicit latency reports or ii) via inferred latency via skew of arrival times for periodic flows and/or simulation tabulated PDF predictions with the most relevant parameters (e.g., CU, number of client devices, offered load per client device, number of non-TUA client devices, number of TUA client devices, etc.).

From stage 210, where computing device 300 determines the observed EDCA latency PDF based on the plurality of parameters, method 200 may advance to stage 220 where computing device 300 may determine a predicted Multi-User Enhanced Distributed Channel Access (MU-EDCA) latency PDF based on the plurality of parameters. For example, embodiments of the disclosure may define a framework for MU-EDCA parameter selection based on either: i) lack of UL latency reports from a client device or ii) availability. It may be observed for MU-EDCA (e.g., from simulations and field data) that TUA/TUA-O creates a bi-modal latency PDF for a certain Access Category (AC) (e.g. Video/VI) where one mode represents the effect of the client device under MU-EDCA and one mode represents the effect of the client device under EDCA when the timeout (TO) expires. This combined PDF may exhibit the second mode at approximately the MU-EDCA timeout (i.e., the client device has escaped).

Once computing device 300 determines the predicted MU-EDCA latency PDF based on the plurality of parameters in stage 220, method 200 may continue to stage 230 where computing device 300 may enable MU-EDCA when the predicted MU-EDCA latency PDF indicates a better delay bound than the EDCA latency PDF. For example, this process of MU-EDCA enablement and TO selection may be based on a latency bounds target (e.g., AC-VI such as 50 ms 99.9 percental). The first stage may be to determine if MU-EDCA/TUA should be enabled based on a comparison of the currently observed EDCA latency PDF versus the predicted MU-EDCA latency PDF under the same parameters (e.g., CU, number of client devices, number of TUA client devices, offered load per client device, etc.). If the delay bound is better met with MU-EDCA (in general) then it may be enabled with a generous default TO (e.g., the Delay Bound itself e.g. 50 ms). MU-EDCA operation may then be observed for some time-period (e.g., 10 s) and an observed PDF may be gathered. As described above, the bi-model characteristic (e.g. multiple local maxima) may be looked at and it may be determined whether to shift the EDCA mode peak (approximately at the MU-EDCA TO value) by reducing the MU-EDCA timeout (i.e., the sum of both modes of the PDF results in better compliance with the Delay Bound as the client device can escape earlier without awaiting TUA from the AP). Once computing device 300 enables MU-EDCA when the predicted MU-EDCA latency PDF indicates the better delay bound than the EDCA latency PDF in stage 230, method 200 may then end at stage 240.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing Multi-User Enhanced Distributed Channel Access (MU-EDCA) optimization for High-Density (HD) enterprises as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
determining, by a computing device, an observed Enhanced Distributed Channel Access (EDCA) latency Probability Density Function (PDF) based on a plurality of parameters;
determining a predicted Multi-User Enhanced Distributed Channel Access (MU-EDCA) latency PDF based on the plurality of parameters; and
enabling MU-EDCA when the predicted MU-EDCA latency PDF indicates a better delay bound than the EDCA latency PDF.

2. The method of claim 1, wherein determining the observed EDCA latency PDF comprises using explicit latency.

3. The method of claim 1, wherein determining the observed EDCA latency PDF comprises using inferred latency.

4. The method of claim 1, wherein when MU-EDCA is enabled, the method further comprising determining an observed MU-EDCA latency PDF for a time period.

5. The method of claim 4, further comprising determining whether to shift an EDCA latency mode peak by reducing/increasing an MU-EDCA timeout value.

6. The method of claim 4, wherein the time period is approximately 10 s.

7. The method of claim 1, wherein the computing device comprises an Access Point (AP).

8. A system comprising:
a memory storage; and
a processing unit coupled to the memory storage, wherein the processing unit is operative to:
determine an observed Enhanced Distributed Channel Access (EDCA) latency Probability Density Function (PDF) based on a plurality of parameters;
determine a predicted Multi-User Enhanced Distributed Channel Access (MU-EDCA) latency PDF based on the plurality of parameters; and
enable MU-EDCA when the predicted MU-EDCA latency PDF indicates a better delay bound than the EDCA latency PDF.

9. The system of claim 8, wherein the processing unit being operative to determine the observed EDCA latency PDF comprises the processing unit being operative to use explicit latency.

10. The system of claim 8, wherein the processing unit being operative to determine the observed EDCA latency PDF comprises the processing unit being operative to use inferred latency.

11. The system of claim 8, wherein the processing unit is further operative to determine an observed MU-EDCA latency PDF for a time period when MU-EDCA is enabled.

12. The system of claim 11, wherein the processing unit is further operative to determine whether to shift an EDCA mode peak by reducing an MU-EDCA timeout value.

13. The system of claim 11, wherein the time period is approximately 10 s.

14. A non-transitory computer-readable medium that stores a set of instructions which when executed perform a method executed by the set of instructions comprising:
determining, by a computing device, an observed Enhanced Distributed Channel Access (EDCA) latency Probability Density Function (PDF) based on a plurality of parameters;
determining a predicted Multi-User Enhanced Distributed Channel Access (MU-EDCA) latency PDF based on the plurality of parameters; and
enabling MU-EDCA when the predicted MU-EDCA latency PDF indicates a better delay bound than the EDCA latency PDF.

15. The non-transitory computer-readable medium of claim 14, wherein determining the observed EDCA latency PDF comprises using explicit latency.

16. The non-transitory computer-readable medium of claim 14, wherein determining the observed EDCA latency PDF comprises using inferred latency.

17. The non-transitory computer-readable medium of claim 14, wherein when MU-EDCA is enabled, the method further comprising determining an observed MU-EDCA latency PDF for a time period.

18. The non-transitory computer-readable medium of claim 17, further comprising determining whether to shift an EDCA mode peak by reducing an MU-EDCA timeout value.

19. The non-transitory computer-readable medium of claim 17, wherein the time period is approximately 10 s.

20. The non-transitory computer-readable medium of claim 14, wherein the computing device comprises an Access Point (AP).
